(19) United States
(12) Patent Application Publication
(10) Pub. No.: US 2010/0246888 A1
(43) Pub. Date: Sep. 30, 2010

(54) IMAGING APPARATUS, IMAGING METHOD AND COMPUTER PROGRAM FOR DETERMINING AN IMAGE OF A REGION OF INTEREST

(75) Inventor: Claas Bontus, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,948

(22) PCT Filed: Nov. 11, 2008
(86) PCT No.: PCT/IB08/54711

§ 371 Date: May 14, 2010

(30) Foreign Application Priority Data
Nov. 19, 2007 (EP) 07120956.3

(51) Int. Cl. G06K 9/00

(52) U.S. Cl. 382/103

(57) ABSTRACT

The present invention relates to an imaging apparatus for determining an image of a region of interest, wherein a motion generation unit (1, 7, 8) moves the radiation source (2) and a region of interest relative to each other along a first trajectory (32), while a detection unit (6) detects first detection data. A reconstruction data determination unit (12) determines reconstruction data among the first detection data and a second trajectory determination unit (13) determines a second trajectory (32) depending on the reconstruction data. After that the motion generation unit (1, 7, 8) moves the radiation source (2) and the region of interest relative to each other along the second trajectory (32), while the detection unit (6) detects second detection data. The reconstruction data and the second detection data are used by a reconstruction unit (14) for reconstructing an image of the region of interest.

### FIELD OF THE INVENTION

The present invention relates to an imaging apparatus, an imaging method and a computer program for determining an image of a region of interest.

### BACKGROUND OF THE INVENTION

A. Katsevich discloses in “Image reconstruction for the circle and line trajectory”, Phys. Med. Biol, vol. 49 (2004), pp. 5059-5072 a computed tomography apparatus comprising an X-ray radiation source and a detection unit, which are rotatable around a region of interest. The computed tomography apparatus further comprises a linearly movable table for moving the region of interest linearly with respect to the X-ray radiation source and the detection unit. Circular detection data are acquired, while the X-ray radiation source and the detection unit rotate around the region of interest and the X-ray radiation source emits radiation, which traverses the region of interest and which is detected by the detection unit. In addition, linear detection data are acquired, while the X-ray radiation source and the detection unit do not rotate and the table and, thus, the region of interest is linearly moved with respect to the X-ray radiation source and the detection unit. During the linear movement the X-ray radiation source emits radiation traversing the region of interest and detected by the detection unit. Images are reconstructed using both, the circular detection data and the linear detection data. The resulting images often show artifacts, for example, if a moving object is present within the region of interest, caused by the use of the circular and linear detection data. This decreases the image quality.

### SUMMARY OF THE INVENTION

It is an object of the present invention to provide an imaging apparatus, an imaging method and a computer program for determining an image of a region of interest, wherein first detection data are detected, while a radiation source and a region of interest move relative to each other along a first trajectory, wherein second detection data are detected, while the radiation source and the region of interest move relative to each other along a second trajectory, and wherein the quality of an image, which is reconstructed by using the first detection data and the second detection data, can be increased.

In a first aspect of the present invention an imaging apparatus for determining an image of a region of interest is presented, wherein the imaging apparatus comprises:

a radiation source for emitting radiation traversing the region of interest,

a detection unit for detecting radiation after having traversed the region of interest,

a motion generation unit for moving the radiation source and the region of interest relative to each other along a first trajectory, while the detection unit detects first detection data,

a reconstruction data determination unit for determining reconstruction data for reconstructing the image of the region of interest, wherein the reconstruction data determination unit is adapted for determining the reconstruction data among the first detection data,

a second trajectory determination unit for determining a second trajectory depending on the reconstruction data,

wherein the motion generation unit is adapted for moving the radiation source and the region of interest relative to each other along the second trajectory, while the detection unit detects second detection data,

wherein the computed tomography apparatus further comprises a reconstruction unit for reconstructing an image of the region of interest using the reconstruction data and the second detection data.

The invention is based on the idea that the position of the first trajectory and the second trajectory relative to each other, i.e. the acquisition geometry, determines the detection data, which can be used for reconstructing an image of the region of interest. For example, in the above mentioned state of the art, in which this dependence on the acquisition geometry is exemplarily explained in detail, the backprojection interval on the circular trajectory, which is useable for reconstructing the image of the region of interest, is determined by the position of the linear and circular trajectory relative to each other, i.e. in the state of the art artifacts are caused by the fact that a backprojection interval for reconstructing an image cannot freely be chosen.

This is, for example, a problem, if there are detection data of higher quality, for example, because of a better signal-to-noise ratio or because of less or no influence by motion within the region of interest, and detection data of lower quality and if the detection data of higher quality cannot be chosen for reconstruction, because the detection data, which are useable for reconstruction, are determined already by the position of the first and second trajectories relative to each other. But, by firstly acquiring the first detection data, than determining the reconstruction data of the first detection data and determining the second trajectory with respect to the reconstruction data, the reconstruction data of the first detection data can be chosen as required in the respective application, for example, such that they are high quality detection data. Thus, the reconstruction data can be chosen such that high quality detection data are used for reconstructing the image of the region of interest, thereby allowing to increase the quality of the image. The imaging apparatus is, for example, a computed tomography apparatus using X-rays. But, the imaging apparatus can also be another imaging modality, like a nuclear imaging apparatus, for example, a single photon emission computed tomography or a positron emission tomography apparatus, a C-arm apparatus or an magnetic resonance imaging apparatus.

The motion generation unit is adapted for moving the radiation source with respect to the region of interest, for moving the region of interest with respect to the radiation source and/or for moving the radiation source and the region of interest both relative to each other.

Preferentially, the motion generation unit is adapted for rotating the rotation source around the region of interest such that the radiation source and the region of interest move relative to each other along a circular trajectory, which is preferentially the first trajectory. It is further preferred that the motion generation unit is adapted for moving the region of interest linearly with respect to the radiation source such that the radiation source and the region of interest move relative to each other along a linear trajectory, if they are not rotated relative to each other, or that they are moved relative to each other along a helical trajectory, if the radiation source and the region of interest are rotated relative to each other, for example, if the radiation source rotates around the region of interest. The second trajectory is preferentially a linear trajectory or an arc trajectory being a part of a helical trajectory.

In a preferred embodiment,

the reconstruction data determination unit is adapted for determining the reconstruction data by determining a backprojection interval on the first trajectory,

the second trajectory determination unit is adapted for determining the second trajectory depending on the reconstruction data related to the backprojection interval on the first trajectory, and

the reconstruction unit is adapted for reconstructing an image of the region of interest by backprojection using the reconstruction data related to the backprojection interval on the first trajectory and the second detection data.

Reconstruction data related to the backprojection interval on the first trajectory are the first detection data, which correspond to radiation source positions on the first trajectory within the determined backprojection interval.

Preferentially, the reconstruction data determination unit is adapted for reconstruction data by determining a back-projection interval on the first trajectory being a short-scan interval. A short-scan interval is an interval covering less than 360°. Thus, reconstruction data of a smaller time interval are used, thereby increasing the temporal resolution of the imaging process and, thus, reducing possible motion artifacts in the reconstructed image which could, for example, be present, if a moving object is present within the region of interest.

It is further preferred, that the second trajectory determination unit is adapted such that the second trajectory and the first trajectory intersect each other at an end of the backprojection interval. Such an arrangement can lead to a complete data set, wherein artifacts caused by an incomplete data set are reduced, resulting in a further improved image quality.

Preferentially, the imaging apparatus further comprises a motion determination unit for determining a motion within the region of interest, wherein the reconstruction data determination unit is adapted for determining the reconstruction data depending on the motion within the region of interest such that during the detection of the reconstruction data the motion within the region of interest is smaller than during the detection of the other data of first detection data. This reduces artifacts in the reconstructed image caused by motion within the region of interest.

The motion determination unit is, for example, an electrocardiograph, which determines different cardiac phases of a heart, which are related to different degrees of motion of the heart. This determined motion, i.e. e.g. the determined cardiac phase, can be used for selecting reconstruction data such that they have been acquired during a rest phase of the heart. The motion determination unit can also be a unit for determining respiratory motion of a patient, for example, by using a respiratory motion determination system using a respiratory motion determining belt surrounding the thorax of the patient. Furthermore, the motion determination unit can be a unit, which determines the motion from the first detection data using a kymogram.

It is further preferred that the reconstruction unit is adapted for reconstructing an image of the region of interest using a κ-reconstruction. This κ-reconstruction allows an exact or quasi-exact reconstruction, wherein artifacts in the reconstructed image caused by approximations are eliminated or at least reduced.

The κ-reconstruction is for example disclosed in “Circular CT in combination with a helical segment”, C. Bontus, P. Koken, T. Köhler, R. Proksa, Phys. Med. Biol., vol. 52 (2007), pp. 107-120, which is herewith incorporated by reference.

It is further preferred that the radiation source is adapted for emitting a cone beam which is sized such that the region of interest is completely within the cone beam during the movement along at least one of the first trajectory and the second trajectory. The aforementioned illumination of all object-points during the acquisition of the first trajectory ensures that every short-scan interval can be selected, for example, such that those data can be used, which are associated with the state of least motion.

It is also preferred that the motion generation unit is adapted for moving the radiation source and the region of interest relative to each other along the first trajectory such that the first detection data are incomplete, wherein the second trajectory determination unit is adapted for determining the second trajectory such that the second detection data complete the first detection data. Incomplete data cause artifacts in the reconstructed image. If, for example, the first trajectory is a circular trajectory and the radiation source emits a cone beam, the first detection data are incomplete. Also by using other first trajectories, the first detection data can be incomplete. By determining the second trajectory such that the second detection data complete the first detection data, complete detection data can be used for reconstructing an image of the region of interest, thereby reducing artifacts in the reconstructed image caused by incomplete data.

In the above mentioned example of a radiation source, which emits a cone beam and which moves along a first trajectory being a circular trajectory relative to the region of interest, a linear trajectory being a second trajectory preferentially completes the first detection data.

Preferentially, a certain trajectory is complete, if for every object point in the region of interest every plane containing that object point intersects at least once with the trajectory.

In a further aspect of the present invention an imaging method for determining an image of a region of interest is presented, wherein the imaging method comprises following steps:
acquiring first detection data by moving a radiation source emitting radiation traversing the region of interest and the region of interest relative to each other along a first trajectory, while the first detection data are detected by detecting the radiation after having traversed the region of interest,

determining reconstruction data for reconstructing the image of the region of interest, wherein the reconstruction data are determined among the first detection data,

determining a second trajectory depending on the reconstruction data,

acquiring second detection data by moving the radiation source emitting radiation traversing the region of interest and the region of interest relative to each other along the second trajectory, while the second detection data are detected by detecting the radiation after having traversed the region of interest,

reconstructing an image of the region of interest using the reconstruction data and the second detection data.

In a further aspect of the present invention a computer program for determining an image of a region of interest is presented, wherein the computer program comprises program code means for causing an imaging apparatus as defined in claim 1 to carry out the steps of the imaging method as defined in claim 9, when the computer program is run on a computer controlling the imaging apparatus.

It shall be understood that the imaging apparatus of claim 1, the imaging method of claim 9 and the computer program of claim 10 have similar and/or identical preferred embodiments as defined in the dependent claims.

It shall be understood that a preferred embodiment of the invention can also be any combination of the dependent claims with the respective independent claim.

### BRIEF DESCRIPTION OF THE DRAWINGS

These and other aspects of the invention will be apparent from and elucidated with reference to the embodiments described hereinafter. In the following drawings

FIG. 1 shows schematically and exemplarily an embodiment of an imaging apparatus for determining an image of a region of interest,

FIG. 2 shows schematically and exemplarily a first trajectory, a second trajectory and a backprojection interval on the first trajectory,

FIG. 3 shows exemplarily a flow chart illustrating an embodiment of an imaging method for determining an image of a region of interest,

FIG. 4 shows schematically and exemplarily a detection surface of a focus-detector,

FIG. 5 shows schematically and exemplarily a detection surface of a centre-detector,

FIGS. 6 and 7 show parallel rays parameterized by focus-detector coordinates,

FIGS. 8 and 9 show parallel rays parameterized by centre-detector coordinates,

FIG. 10 shows a projection of a circular trajectory on a planar detector,

FIG. 11 shows a projection of a circular trajectory on a planar detector,

FIGS. 12 and 13 show filter lines with filter directions from left to right, and

FIGS. 14 and 15 show filter lines with filtered directions from right to left.

### DETAILED DESCRIPTION OF EMBODIMENTS

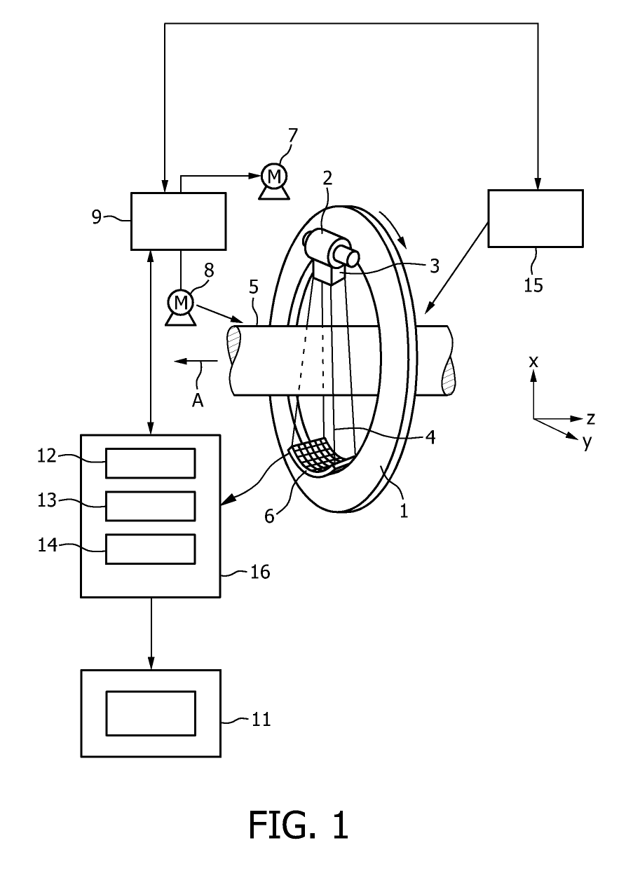

FIG. 1 shows schematically and exemplarily an imaging apparatus for determining an image of a region of interest being, in this embodiment, a computed tomography apparatus. The computed tomography apparatus includes a gantry 1 which is capable of rotation around a rotational axis A which extends parallel to a z direction. A radiation source 2 which is, in this embodiment, an X-ray tube, is mounted on the gantry 1. The radiation source 2 is provided with a collimator 3, which forms, in this embodiment, a conical radiation beam 4 from the radiation generated by the radiation source 2. The radiation traverses a region of interest, in particular, within an object like a patient, in an examination zone 5, which is, in this embodiment, cylindrical. After having traversed the examination zone 5 and, thus, the region of interest, the radiation beam 4 is incident on a detection unit 6, which comprises a two dimensional detection surface in this embodiment. The detection unit 6 is also mounted on the gantry 1.

The computed tomography apparatus comprises two motors 7, 8. The gantry 1 is driven at a preferable constant but adjustable angular speed by the motor 7. The motor 8 is provided for displacing the region of interest, i.e., in this embodiment, an object like a patient, who is arranged on a patient table within the examination zone 5, parallel to the direction of the rotational axis A or the z axis. These motors 7, 8 are controlled by a control unit 9, for instance, such that the radiation source and the examination zone and, thus, the region of interest within the examination 5 move relative to each other along a helical trajectory, a circular trajectory of a linear trajectory. If the radiation source 2 is not rotated and the region of interest is displaced parallel to the direction of the rotational axis A or the z axis, the radiation source moves relative to the examination zone along a linear trajectory, i.e. radiation source and the region of interest move relative to each other along a linear trajectory. If in addition, the radiation source 2 rotates around the region of interest, the radiation source 2 and the region of interest move relative to each other along a helical trajectory, and if the region of interest is not moved and only the radiation source 2 is rotated around the region of interest, the radiation source 2 moves relative to the region of interest along a circular trajectory, i.e. the radiation source 2 and the region of interest move relative to each other along a circular trajectory.

In another embodiment, the collimator 3 can be adapted for forming another beam shape, in particular a fan beam, and the detection unit 6 can comprise a detection surface, which is shaped corresponding to the other beam shape, in particular to the fan beam, i.e., for example, the detection surface can comprise only one line of detection elements.

During a relative movement of the radiation source and the examination zone 5 and, thus, the region of interest, the detection unit 6 generates detection data depending on the radiation incident on the detection surface of the detection unit 6.

The gantry 1, the motors 7, 8 and preferentially a patient table constitute, in this embodiment, a motion generation unit for moving the radiation source and the region of interest relative to each other along a first trajectory, which is preferentially a circular trajectory.

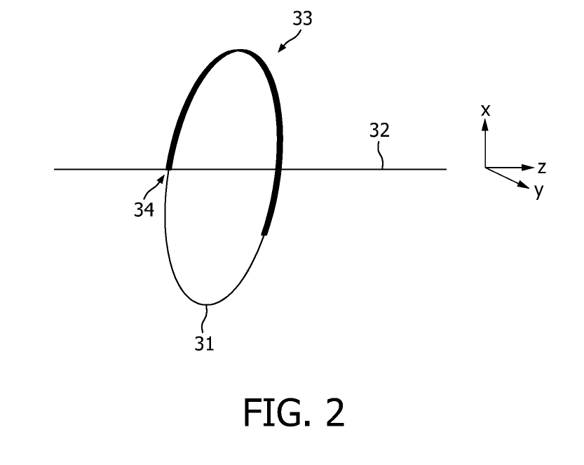

The imaging apparatus further comprises a reconstruction data determination unit 12 for determining reconstruction data for reconstructing an image of the region of interest. The determined reconstruction data are data among the first detection data, i.e. the reconstruction data are preferentially selected from the first detection data. Preferentially, the reconstruction data determination unit determines the reconstruction data by determining a backprojection interval 33, which is schematically and exemplarily shown in FIG. 2, on the first trajectory 31. The determined backprojection interval 33 is preferentially a short-scan interval, i.e. an interval covering less than 360°. The preferred length of the short-scan interval for a particular point within the region of interest, which should be reconstructed, covers a range of 180 degrees seen from the perspective of the point. Thus, a short-scan interval is determined preferentially such that it covers for each point within the region of interest, which has to be reconstructed, a range of at least 180° seen from the perspective of the respective point. Preferentially, for reconstructing a point within a region of interest reconstruction data are used among first detection data, which correspond to radiation source positions located within the short-scan interval. In particular, the short-scan interval is preferentially chosen such that the corresponding first detection data have been acquired, while, in this embodiment, an object within the region of interest is in a state of least motion.

In this embodiment, the reconstruction data determination unit 12 is adapted for determining the reconstruction data, i.e. in this embodiment, the backprojection interval 33 on the first trajectory 31, depending on a motion within the region of interest such that during the detection of the reconstruction data the motion within the region of interest is smaller than during the detection of the other data of first detection data. If, for example a heart of a patient is present in the region of interest, the reconstruction data, i.e. in this embodiment the backprojection interval 33 on the first trajectory 31, are determined such that the reconstruction data have been acquired during the rest phase of the heart. For the determination of the heart phases, i.e. in this embodiment the determination of the motion within the region of interest, the imaging apparatus comprises a motion determination unit 15 being, in this embodiment, an electrocardiograph. The electrocardiograph determines an electrocardiogram, which is transferred via the control unit 9 or directly to the reconstruction data determination unit 12 such that the reconstruction data determination unit 12 can determine the reconstruction data depending on the motion of the heart. Preferentially, the reconstruction data determination unit 12 determines a backprojection interval based on a phase point, which is associated with least motion. Such a phase point is determined from the electrocardiogram. The backprojection interval is preferentially determined such that the phase point is centred within the backprojection interval, wherein the width is preferentially chosen such that the reconstruction data, which correspond to this backprojection interval, fulfil the sufficiency condition for all points within the region of interest, which have to be reconstructed. Furthermore, preferentially the backprojection interval is chosen such that it correspondence to a minimum amount of data, which are needed for fulfilling the sufficiency condition, preferentially such that a minimum amount of data with a large distance to the phase point is used.

The sufficiency condition is fulfilled, if the data acquired with both trajectories are complete.

The radiation source 2 with the collimator 3 is preferentially adapted such that a cone beam is emitted. The cone beam is preferentially sized such that the region of interest is completely within the cone beam during the movement along the first trajectory being, in this embodiment, a circular trajectory 31. For example, if a heart of a patient should be imaged, the cone beam is preferentially sized such that the heart is completely located within the cone beam during the acquisition of the first detection data and/or the second detection data.

The imaging apparatus further comprises a second trajectory determination unit 13 for determining a second trajectory 32 depending on the reconstruction data. Thus, after the reconstruction data have been determined by the reconstruction data determination unit 12, the second trajectory determination unit 13 determines the second trajectory 32. In this embodiment, the reconstruction data have been determined by determining a backprojection interval 33 on the first trajectory 31 and the second trajectory 32 is determined such that it intersects the first trajectory 31 at an end 34, in particular, at an end point, of the backprojection interval 32.

Since the second trajectory is determined after determining the reconstruction data, i.e. in this embodiment, after determining the backprojection interval 33 on the first trajectory 31, the reconstruction data can freely be chosen from the first detection data. Of course, the reconstruction data have to be chosen such that the reconstruction data fulfil the sufficiency condition for reconstructing an image of the region of interest.

The motion generation unit is adapted for moving the radiation source 2 and the region of interest relative to each other along the second trajectory 32, while the detection unit 6 detects second detection data.

In this embodiment, the first trajectory 31 is a circular trajectory and the first detection data acquired, while the radiation source 2 moves relative to the region of interest along the first trajectory 31, are incomplete. The second trajectory 32 being, in this embodiment a linear trajectory, completes the incomplete first detection data and reduces therefore artifacts caused by an incomplete data set in a reconstructed image.

The imaging apparatus further comprises a reconstruction unit 14 for reconstructing an image of the region of interest using the reconstruction data, i.e., in this embodiment, the first detection data related to the backprojection interval 33, and the second detection data. The reconstruction unit 14 is preferentially adapted for reconstructing an image of the region of interest using a κ-reconstruction. A preferred embodiment of such a κ-reconstruction will be explained further below.

In this embodiment, the reconstruction data determination unit 12, the second trajectory determination unit 13 and the reconstruction unit 14 are located within a calculation unit 16. In other embodiments, one, some or all of the reconstruction determination unit 12, the second trajectory determination unit 13 and the reconstruction unit 14 can be separate units, which are not combined to a calculation unit.

For the determination of the reconstruction data among the first detection data, the first detection data are provided to the reconstruction data determination unit 12.

The second trajectory determination unit 13 transfers signals corresponding to the determined second trajectory to the control unit 9 for controlling the motion generation unit such that the radiation source and the region of interest move relative to each other along the second trajectory, while the detection unit 6 detects the second detection data.

The second detection data and at least the reconstruction data are provided to the reconstruction unit 14 for allowing the reconstruction 14 to reconstruct an image of the region of interest using the reconstruction data and the second detection data. The reconstructed image is provided to a display unit 11 for displaying the reconstructed image.

Also the reconstruction data determination unit 12, the second trajectory determination unit 13 and the reconstruction unit 14 are preferentially controlled by the control unit 9.

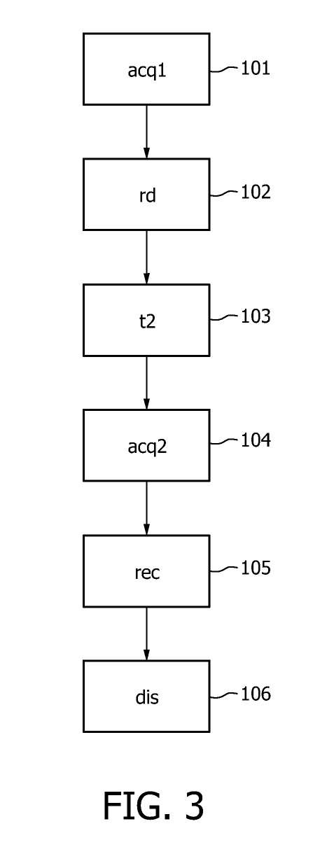

In the following an imaging method for determining an image of a region of interest will be described with reference to a flow chart shown in FIG. 3.

The imaging method for determining an image of a region of interest is, in this embodiment, a computed tomography method. In step 101, the radiation source 2 rotates around the rotational axis A and the examination zone 5 and, thus, the region of interest within an object, in particular within a patient on a patient table, is not moved, i.e. the radiation source 2 travels along a first trajectory 31 being in this embodiment a circular trajectory around the region of interest. In another embodiment, the first trajectory can also be another trajectory, for example, a helical or linear trajectory. The radiation source 2 emits radiation, in this embodiment, conical radiation, traversing the region of interest, in which an object is present. The radiation, which has traversed the region of interest is detected by the detection unit 6, which generates first detection data.

During the acquisition of the first detection data in step 101, in this embodiment, the motion determination unit 15 being, in this embodiment, an electrocardiograph determines motion within the region of interest. In this embodiment, a heart of a patient is present in the region of interest and the motion determination unit 15 determines an electrocardiogram, which is related to the motion of the heart, i.e. the motion of the heart is determined by determining the electrocardiogram.

The first detection data and preferentially data describing the determined motion, i.e. in this embodiment an electrocardiogram, are transferred to the reconstruction data determination unit 12, which determines reconstruction data, i.e. in this embodiment a backprojection interval 33 on the first trajectory 31, for reconstructing the image of the region of interest in step 102. Thus, in step 102 reconstruction data are selected from the first detection data.

In this embodiment, the reconstruction data determination unit 12 determines the reconstruction data, i.e., in this embodiment, the backprojection interval 33 on the first trajectory 31, depending on the motion within the region of interest, i.e., in this embodiment, depending on the electrocardiogram, such that during the detection of the reconstruction data the motion within the region of interest is smaller than during the detection of the other data of the first detection data.

In step 103, the second trajectory determination unit 13 determines a second trajectory 32 depending on the reconstruction data, i.e., in this embodiment, depending on the determined backprojection interval 33 on the first trajectory 31. In this embodiment, the second trajectory is determined such that it intersects an end of the backprojection interval 33. Furthermore, in this embodiment, the second trajectory is a linear trajectory parallel to the rotational axis R or the z axis. In other embodiments, the second trajectory can be another trajectory, for example, an arc trajectory being a part of a helical or circular trajectory.

In step 104, the motion generation unit moves the radiation source 2 and the region of interest relative to each other along the second trajectory 32, while the detection unit 6 detects second detection data, i.e. second detection data are acquired. In this embodiment, the radiation source 2 does not rotate around the rotational axis R or the z axis and the region of interest is displaced parallel to the rotational axis R or the z axis during the acquisition of the second detection data. In particular a patient table, on which an object like a patient can be present, is moved parallel to the rotational axis A or the z axis.

Also in step 104, during the acquisition of the second detection data, the motion determination unit 15 preferentially determines the motion within the region of interest, i.e., in this embodiment, the electrocardiograph determines an electrocardiogram during the acquisition of the second detection data.

In step 105, the reconstruction unit 15 reconstructs an image of the region of interest using the reconstruction data, i.e., in this embodiment, the first detection data related to the backprojection interval 33 on the first trajectory 31, and the second detection data. The reconstruction unit 14 preferentially uses a κ-reconstruction. A preferred embodiment of such a κ-reconstruction will be explained further below.

In step 106, the reconstructed image is provided to the display unit 11 for displaying the reconstructed image.

Preferentially, during the acquisition of the second detection data only a low radiation dose is used, which is smaller than the radiation dose used during the acquisition of the first detection data, in particular, because the second detection data are used only for completing the first detection data. For example, the tube current for acquiring data along the first trajectory is preferentially larger than 100 mA, and is further preferred 400 mA, while the tube current for acquiring data along the second trajectory is preferentially smaller than 100 mA, further preferred smaller than 50 mA, in particular one tenth of the tube current for acquiring data along the first trajectory or smaller, and is for example 40 mA.

In the following a preferred embodiment of a x-reconstruction will be explained.

In this embodiment, the first trajectory is a circular trajectory located in the xy-plane and the second trajectory is a linear trajectory parallel to the z axis. Points on these trajectories can be parameterized according to following equation:

$${y}_{0} ( s ) = ( \begin{matrix}R cos s \\ R sin s \\ 0\end{matrix} ) , \\ {y}_{1} ( z ) = ( \begin{matrix}R \\ 0 \\ z\end{matrix} ) \qquad ( 1 )$$

In equation (1), A corresponds to the distance from the source to the rotational axis, and s is an angular variable parameterising the trajectory.

In the following, an analysis of detector shapes will be described.

A conventional CT scanner usually contains a detector, which is part of a cylinder surface. The symmetry axis of this cylinder may be parallel to the z-axis and may contain the focal spot. Points on such a “focus-detector” can be parameterized using an angular variable α and a variable v_{F}. For a source located on the linear trajectory at z=z₀, a vector r_{F} pointing from the origin to the element on the focus-detector is given by equation (2):

$${r}_{F} ( α , {v}_{F} , {z}_{0} ) = ( \begin{matrix}R - D cos α \\ D sin α \\ {z}_{0} + {v}_{F}\end{matrix} ) \qquad ( 2 )$$

In equation (2), D corresponds to the distance from the source to the detector-centre.

For convenience, a virtual “center-detector” may be introduced. Similar to the focus-detector, the center-detector is located on the surface of a cylinder. The symmetry axis of the cylinder corresponds to the z-axis, now, such that the points on the detector can be parameterized by introducing a vector r_{C}:

$${r}_{C} ( β , {v}_{C} , {z}_{0} ) = ( \begin{matrix}- R cos β \\ R sin β \\ {z}_{0} + {v}_{C}\end{matrix} ) \qquad ( 3 )$$

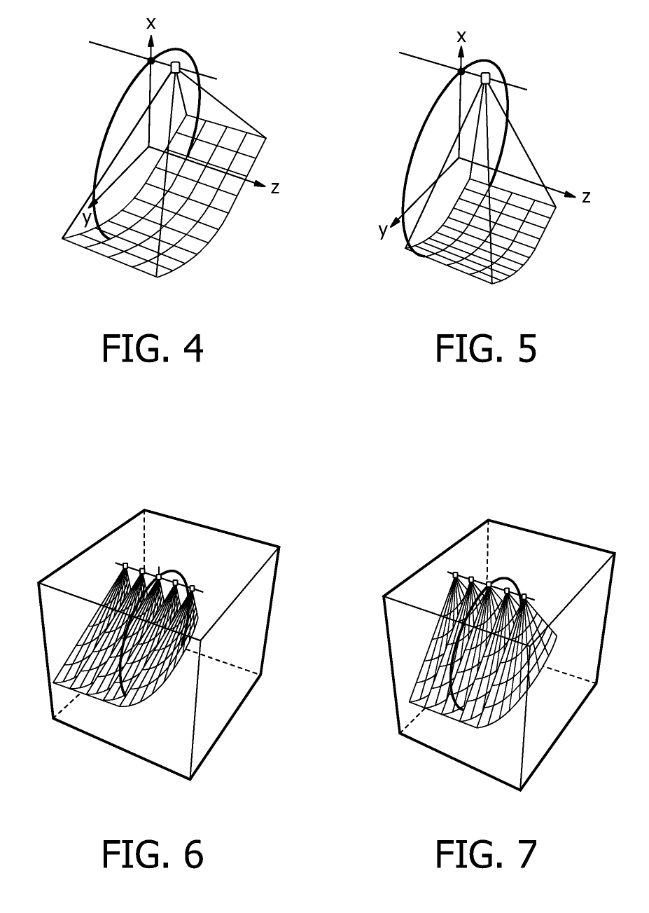

In equation (3), β and v_{C} are detector coordinates in complete analogy to the focus-detector coordinates α and v_{F}. FIG. 4 and FIG. 5 exemplify the trajectory and the focus- and center-detector. Particularly, FIG. 4 shows the focus-detector approach, wherein FIG. 5 shows the center-detector approach.

The line containing the focal spot and a certain focus-detector element can be parameterized as l_{F}, see equation (4):

$${l}_{F} ( α , {v}_{F} , {z}_{0} , σ ) = ( \begin{matrix}R \\ 0 \\ {z}_{0}\end{matrix} ) + σ ( \begin{matrix}- D cos α \\ D sin α \\ {v}_{F}\end{matrix} ) , 0 \leq σ \leq 1 \qquad ( 4 )$$

Using equation (4), the coordinates of the detector-element onto which an object point x=(x, y, z) is projected can be computed:

$$tan α = \frac{y}{R - x} ⇒ σ = \frac{R - x}{D cos α} ⇒ {v}_{f} = \frac{z - {z}_{0}}{σ} \qquad ( 5 )$$

Similarly, the line containing the focal-spot and a center-detector element can be parameterized according to equation (6):

$${l}_{C} ( β , {v}_{C} , {z}_{0} , σ ) = ( \begin{matrix}R \\ 0 \\ {z}_{0}\end{matrix} ) + σ ( \begin{matrix}- R ( 1 + cos β ) \\ R sin β \\ {v}_{C}\end{matrix} ) , 0 \leq σ \leq 1 \qquad ( 6 )$$

The object-point is projected onto the detector-element with coordinates:

$$tan \frac{β}{2} = \frac{y}{R - x} ⇒ σ = \frac{R - x}{R ( 1 + co s β )} = \frac{R - x}{2 {R cos}^{2 \frac{β}{2}}} ⇒ {v}_{C} = \frac{z - {z}_{0}}{σ} \qquad ( 7 )$$

Both, for the focus-detector and center-detector, the coordinates α and β depend only on x, y, while v_{F} and v_{C} depend on x, y and z.

In the following, an analysis of parallel rays will be described.

A physical detector may comprise columns and rows. The corresponding detector elements may be equidistantly separated in the variables α and v_{F}. Therefore, equations (8) and (9) parameterize the centers of the detector-elements for fixed z=z₀:

αₖ=α₀+kΔα, k=0, . . . , # columns−1 (8)

v_{Fp}=v_{F0}+pΔv_{F}, p=0, . . . , # rows−1 (9)

For mathematical reasons, it may be convenient to reorganize the data taken along the linear trajectory, before the back-projection is performed. For projection data associated with a parallel-detector, data from different source-positions may be combined. Using center-detector coordinates, the parameterization of the coordinates in parallel-geometry is given, for a fixed v_{C}, by equations (10), (11):

βₖ=β₀+kΔ⊕, k=0, . . . , # columns−1 (10)

z_{0,p}=z_{0,min}+pΔz, p=0, . . . , # projections−1 (11)

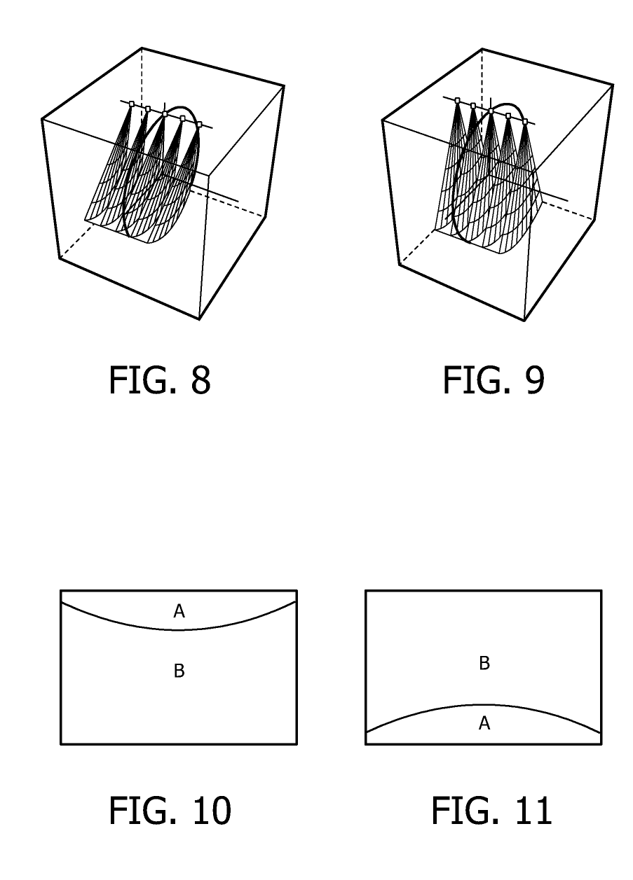

In equations (10) and (11), Δz corresponds to the distance between two successive projections on the trajectory-line. FIG. 6 to FIG. 9 each exemplify two parallel projections, for the focus-detector and for the centre-detector, respectively. Particularly, FIG. 6 and FIG. 7 show parallel rays parameterized by focus-detector coordinates. FIG. 8, FIG. 9 show parallel rays parameterized by center-detector coordinates.

Since v_{C} is fixed for a given parallel-projection, equation (7) can be used in order to determine the detector-column and the detector-row onto which a given object point x=(x, y, z) is projected. For this, β and σ are first computed, and then these values are used in order to determine z₀=z−σv_{C}.

In the following, an analysis of a reconstruction scheme will be illustrated.

For every position y on the trajectory, the measured projection data D_{f} can be described by equation (12):

$${D}_{f} ( y , Θ ) = {\int }_{0}^{∞} d lf ( y + l Θ ) \qquad ( 12 )$$

In other words, from every position y, line integrals along rays are considered pointing onto a certain set of directions described by different unit vectors 0. For convenience, it is set for the linear trajectory y_{|}(s)=y_{L}(z=hs), where h>0 is an arbitrary constant.

A first reconstruction step consists of differentiating the data as follows:

$${D}_{f}^{′} ( y ( s ) , Θ ) = \frac{\partial {D}_{f} ( y ( s ) , Θ = const . )}{\partial s} \qquad ( 13 )$$

In other words, equation (13) means the data are taken from different projections associated with parallel rays which are to be considered. The differentiation step of equation (13) can, for instance, be performed using a Fourier filter. Next, the data are filtered using a 1/sinγ filter. For this, the filter directions are determined first. They depend on the position of the focal-spot and on the point onto which the object-point to be reconstructed is projected. Denoting the position of the object-point as x, equation (14) defines the unit vector b:

$$b ( s , x ) = \frac{x - y ( s )}{\vert x - y ( s ) \vert} \qquad ( 14 )$$

That is to say, b points from the source to the object-point. The filter directions can be characterized, using unit vectors e, which are perpendicular to b. The relationship between e-vectors and filter-lines is described in the appendix of Bontus, C. et al. “A quasiexact reconstruction algorithm for helical CT using a 3-Pi acquisition”, Med. Phys. 30, 2493-2502 (2003). For every s and for every x, there can be one or more filter directions which have to be used. Using b and e, the filtering step can be described by equation (15):

$$P ( s , b ) = {\sum }_{q = 1}^{{N}_{f}} {\int }_{- π}^{π} \frac{d γ}{sin γ} {D}_{f}^{′} ( y ( s ) , cos γ b + sin γ {e}_{q} ) \qquad ( 15 )$$

The sum over q in equation (15) is performed, because there can be more than one filter direction. A definition of the vectors e is crucial, for the described embodiment. Once the filtered data have been obtained, the back-projection can be written according to equation (16):

$$f ( x ) = \frac{( - 1 )}{2 {π}^{2}} {\int }_{I} \frac{ d s}{\vert x - y ( s ) \vert} P ( s , b ( s , x ) ) \qquad ( 16 )$$

Within equation (16), “I” denotes the back-projection interval.

Certainly, the described procedure has to be applied separately to the circular trajectory, wherein the backprojection interval determined by the reconstruction data determination unit 12 is used, and to the linear trajectory. In particular, y(s) in equations (13), (15) and (16) corresponds to either y₀(s) or y_{|}(s). Finally, both results of equation (16) are added up.

In the following, an analysis of back-projection and parallel geometry will be described.

If a rebinning into parallel geometry is performed after the filtering step in equation (15), the back-projection formula of equation (16) changes. In particular, for the circular trajectory, the formula is the same as given in WO 2004/044849 A1. For the linear trajectory, the back-projection is preferentially performed by using equation (17):

$$f ( x ) = \frac{( - 1 )}{2 {π}^{2}} \frac{1}{h} \int d {v}_{F} \frac{cos λ}{R} P ( {v}_{F} , b ( {v}_{F} , x ) ) \qquad ( 17 )$$

if the parallel data are parameterized by focus-detector coordinates, and by using

$$f ( x ) = \frac{( - 1 )}{2 {π}^{2}} \frac{1}{h} \int d {v}_{C} \frac{cos λ}{l} P ( {v}_{C} , b ( {v}_{C} , x ) ) , l = 2 R cos β \qquad ( 18 )$$

if the parallel data are parameterized by center-detector coordinates. In these equations, h was introduced above, when defining y_{|}(s)=y_{L}(z=hs), and λ corresponds to the cone-angle of a particular ray. The value of λ can be computed using equation (19):

$$tan λ = \frac{{v}_{F}}{D} = \frac{{v}_{C}}{l} . \qquad ( 19 )$$

An advantage of equations (17) and (18) compared with equation (16) is that no object-point dependent factor |x-| needs to be computed. This significantly reduces the calculation time by reducing the computational burden for calculating a reconstructed image. The filtered data have to be multiplied only with factors depending on the detector coordinates α, β, v_{F} or v_{C}.

In the following, an analysis of filter-lines for the circular trajectory will be described.

As described in the reference Bontus, C. et al, “A quasiexact reconstruction algorithm for helical CT using a 3-Pi acquisition”, Med-Phys. 30, 2493-2502 (2003), it may be advantageous to introduce a virtual plane detector containing the rotational axis. Coordinates on this detector are denoted as u_{PL} and v_{PL} and the v_{PL}-axis is parallel to the z-axis. A line is considered containing the source and being perpendicular to the plane detector. The point (u_{PL}=0, v_{PL}=0) corresponds to the point in which this line intersects with the planar detector. Now, each filter line can be described according to equation (20):

v_{Pl}(u_{Pl})=v₀+σu_{Pl} (20)

In other words, it corresponds to a straight line on the planar detector. In general, the gradient σ is different for different filter-lines.

For the described algorithm, the first detection data are filtered along lines parallel to the u_{PL}-axis, that is to say v_{PL} (u_{PL})=v₀. The different lines are parameterized by v₀. The filter direction goes from left to right.

In the following, an analysis of the filter-lines for the linear trajectory will be described.

For the parameterization of the filter-lines for the linear trajectory, it is first considered the projection of the circular trajectory onto the planar detector as seen from a source at z=z₀. In particular, this projection can be described as

$${v}_{Pl} ( {u}_{Pl} ) = - \frac{{z}_{0}}{2} [ 1 + {( \frac{{u}_{Pl}}{R} )}^{2} ] . \qquad ( 21 )$$

FIG. 10 and FIG. 11 show the projections of the circular trajectory for two different z₀. Particularly, FIG. 10 shows a projection of the circular trajectory onto the planar detector seen from z₀<0. FIG. 11 shows a projection of the circular trajectory onto the planar detector seen from z₀>0. The detector area is divided into two regions A and B as shown in FIG. 10 and FIG. 11. If the object-point is projected into region A, the projection data associated with a current source position is not used for the reconstruction. Therefore, the data in region A should be set to zero. For region B, the filter lines may be defined as follows.

A line tangential to the projected circular trajectory can be parameterized using equation (22):

$${v}_{Pl} ( {u}_{Pl} ) = - \frac{{z}_{0}}{2} [ 1 + {( \frac{{u}_{0}}{R} )}^{2} ] - \frac{{z}_{0} {u}_{0}}{{R}^{2}} ( {u}_{Pl} - {u}_{0} ) \qquad ( 22 )$$

In equation (22), u₀ is the coordinate at which the line is tangential. In particular, if one looks for the tangential line containing the point (u₁, v₁), the parameter u₀ can be computed according to equation (23):

$${u}_{0} = {u}_{1} \pm \sqrt{{u}_{1}^{2} + {R}^{2} ( 1 + 2 \frac{{v}_{1}}{{z}_{0}} )} \qquad ( 23 )$$

The sign in front of the square-root has to be chosen depending on, if the tangential point is desired to be located left (minus) or right (plus) of (u₁, v₁).

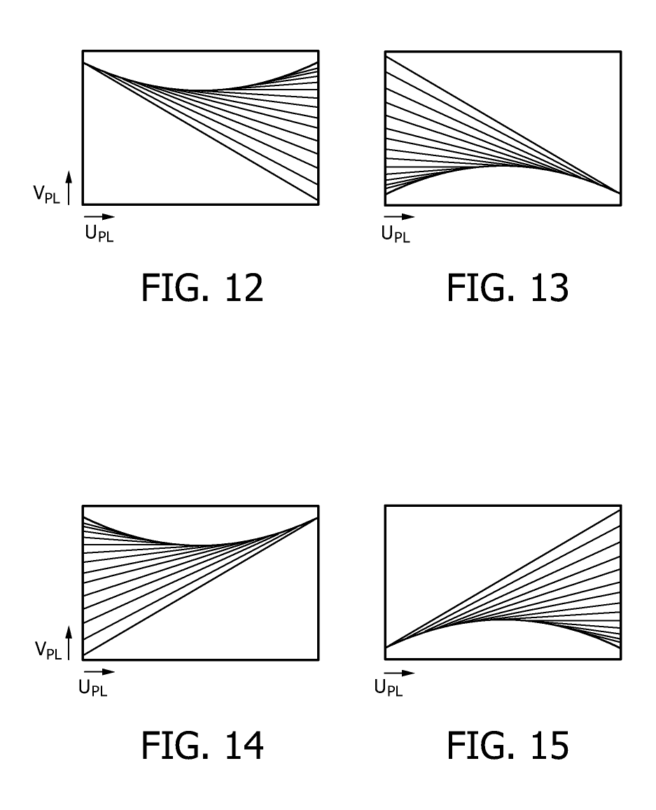

Now, the filter-lines are sets of lines which are tangential to the projected circular trajectory. FIG. 12 to FIG. 15 exemplify these lines. FIG. 12, FIG. 13 show filter lines with different filter directions from left to right. FIG. 14, FIG. 15 show filter lines with filter directions from right to left. In particular, for each point (u_{PL}, v_{PL}), the contributions of two different filter-lines are used. For the first one, the tangential point is on the left, for the second one it is on the right of (u_{PL}, v_{PL}). The direction of filtering depends on z₀. If z₀<0, the filtering goes from left to right, if the tangential point is on the left, while it goes from right to left, if the tangential point is on the right. If z₀>0, the filtering goes from left to right, if the tangential point is on the right, while it goes from right to left, if the tangential point is on the left. FIG. 12 to FIG. 15 illustrate this.

The filter lines shown in FIG. 12 to FIG. 15 cover only part of the detector. Trying to cover a larger part would necessarily result in an extrapolation, since the filter-lines would become very steep. In any case, only data from regions for which two filter-lines are defined, should be used for the backprojection.

Although in the above described embodiment the reconstruction 14 uses a κ-reconstruction, also other reconstruction methods can be used for reconstructing an image of the region of interest like, for example, a standard filtered backprojection, which uses approximations, or a Radon inversion.

Although in the above described embodiment, an image a heart of a patient has been reconstructed, the invention is also applicable to other parts of a patient, in particular to other organs. Furthermore, the invention is applicable also to technical objects, for example, in the field of baggage inspection.

In the above described embodiment, the first trajectory is a circular trajectory and the second trajectory is linear trajectory. But, in other embodiments, the first trajectory and the second trajectory can be other trajectories, for example, the second trajectory can also be an arc trajectory being a part of a helical trajectory. Furthermore, also the first trajectory can be a helical trajectory.

In addition to the first and second trajectory, the motion generation unit can also be adapted to move the radiation source and the region of interest relative to each other along one or more further trajectories.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Determinations, calculations, like the reconstruction, and the control of the imaging apparatus performed by one or several units or devices can be performed by any other number of units or devices. For example, the determination of reconstruction data in step 102 and the reconstruction of an image of the region of interest using the reconstruction data and the second detection data can be performed by a single unit or by any other number of different units. The calculations and determinations and/or the control of the imaging apparatus in accordance with the above described imaging method can be implemented as program code means of a computer program and/or as dedicated hardware.

A computer program may be stored/distributed on a suitable medium, such as an optical storage medium or a solid-state medium supplied together with or as part of other hardware, but may also be distributed in other forms, such as via the internet or other wired or wireless telecommunication systems.

Any reference signs in the claims should not be construed as limiting the scope.

1. An imaging apparatus for determining an image of a region of interest, the imaging apparatus comprising
a radiation source (2) for emitting radiation traversing the region of interest,
a detection unit (6) for detecting radiation after having traversed the region of interest,
a motion generation unit (1, 7, 8) for moving the radiation source and the region of interest relative to each other along a first trajectory (32), while the detection unit (6) detects first detection data,
a reconstruction data determination unit (12) for determining reconstruction data for reconstructing the image of the region of interest, wherein the reconstruction data determination unit (12) is adapted for determining the reconstruction data among the first detection data,
a second trajectory determination unit (13) for determining a second trajectory (32) depending on the reconstruction data,
wherein the motion generation unit (1, 7, 8) is adapted for moving the radiation source (2) and the region of interest relative to each other along the second trajectory (32), while the detection unit (6) detects second detection data,
wherein the computed tomography apparatus further comprises a reconstruction unit (14) for reconstructing an image of the region of interest using the reconstruction data and the second detection data.

2. The imaging apparatus as defined in claim 1, wherein
the reconstruction data determination unit (12) is adapted for determining the reconstruction data by determining a backprojection interval (33) on the first trajectory,
the second trajectory determination unit (13) is adapted for determining the second trajectory depending on the reconstruction data related to the backprojection interval (33) on the first trajectory, and
the reconstruction unit (14) is adapted for reconstructing an image of the region of interest by backprojection using the reconstruction data related to the backprojection interval on the first trajectory and the second detection data.

3. The imaging apparatus as defined in claim 2, wherein the reconstruction data determination unit is adapted for reconstruction data by determining a back-projection interval on the first trajectory being a short-scan interval.

4. The imaging apparatus as defined in claim 2, wherein the second trajectory determination unit is adapted such that the second trajectory and the first trajectory intersect each other at an end (34) of the backprojection interval (33).

5. The imaging apparatus as defined in claim 1, further comprising a motion determination unit (15) for determining a motion within the region of interest, wherein the reconstruction data determination unit (12) is adapted for determining the reconstruction data depending on the motion within the region of interest such that during the detection of the reconstruction data the motion within the region of interest is smaller than during the detection of the other data of first detection data.

6. The imaging apparatus as defined in claim 1, wherein the reconstruction unit (14) is adapted for reconstructing an image of the region of interest using a κ-reconstruction.

7. The imaging apparatus as defined in claim 1, wherein the radiation source (2) is adapted for emitting a cone beam which is sized such that the region of interest is completely within the cone beam during the movement along at least one of the first trajectory and the second trajectory.

8. The imaging apparatus as defined in claim 1, wherein the motion generation unit (1, 7, 8) is adapted for moving the radiation source and the region of interest relative to each other along the first trajectory such that the first detection data are incomplete and wherein the second trajectory determination unit is adapted for determining the second trajectory such that the second detection date complete the first detection data.

9. An imaging method for determining an image of a region of interest, the imaging method comprising following steps:
acquiring first detection data by moving a radiation source emitting radiation traversing the region of interest and the region of interest relative to each other along a first trajectory, while the first detection data are detected by detecting the radiation after having traversed the region of interest,
determining reconstruction data for reconstructing the image of the region of interest, wherein the reconstruction data are determined among the first detection data,
determining a second trajectory depending on the reconstruction data,
acquiring second detection data by moving the radiation source emitting radiation traversing the region of interest and the region of interest relative to each other along the second trajectory, while the second detection data are detected by detecting the radiation after having traversed the region of interest,
reconstructing an image of the region of interest using the reconstruction data and the second detection data.

10. A computer program for determining an image of a region of interest, the computer program comprising program code means for causing an imaging apparatus for determining an image of a region of interest, the imaging apparatus comprising
a radiation source (2) for emitting radiation traversing the region of interest,
a detection unit (6) for detecting radiation after having traversed the region of interest,
a motion generation unit (1, 7, 8) for moving the radiation source and the region of interest relative to each other along a first trajectory (32), while the detection unit (6) detects first detection data,
a reconstruction data determination unit (12) for determining reconstruction data for reconstructing the image of the region of interest, wherein the reconstruction data determination unit (12) is adapted for determining the reconstruction data among the first detection data,
a second trajectory determination unit (13) for determining a second trajectory (32) depending on the reconstruction data,
wherein the motion generation unit (1, 7, 8) is adapted for moving the radiation source (2) and the region of interest relative to each other along the second trajectory (32), while the detection unit (6) detects second detection data,
wherein the computed tomography apparatus further comprises a reconstruction unit (14) for reconstructing an image of the region of interest using the reconstruction data and the second detection data to carry out the steps of the imaging method as defined in claim 9, when the computer program is run on a computer controlling the imaging apparatus.
